(19) United States
(12) Patent Application Publication
(10) Pub. No.: US 2020/0340511 A1
(43) Pub. Date: Oct. 29, 2020

(54) REFRACTORY ANCHOR

(71) Applicant: Silicon Refractory Anchoring Systems B.V., WATERINGEN (NL)

(72) Inventors: DANIELLE FRANCESCA GAROT, WATERINGEN (NL); Jerome Michael GAROT, WATERINGEN (NL); Wouter GAROT, WATERINGEN (NL)

(21) Appl. No.: 16/855,454

(22) Filed: Apr. 22, 2020

(30) Foreign Application Priority Data
Apr. 26, 2019 (NL) 2023014

(51) Int. Cl. F16B 5/08; F16B 37/06; B23K 9/20

(52) U.S. Cl. CPC F16B 5/08; B23K 9/20; F16B 37/061

(57) ABSTRACT

A refractory anchor including an elongated mounting pin of which one end is weldable to an object and a plate-like anchor fin connected to the elongated mounting pin. The refractory anchor(s) may be included in an assembly in which a number of refractory anchors are welded to an object, and also disclosed is a method for manufacturing the assembly.

### TECHNICAL FIELD AND BACKGROUND

The invention relates to a refractory anchor comprising an elongated mounting pin of which one end is weldable to an object and a plate-like anchor fin connected to the elongated mounting pin.

The invention further relates to an assembly comprising an object and a number of refractory anchors welded to the object, and to a method for manufacturing the assembly.

US 2015/0013264 discloses an anchoring assembly used for anchoring a liner of a cured lining material arranged to be applied in liquid form to a metal object which is provided with the anchoring assembly. The anchoring assembly comprises an elongated mounting pin which is arranged to be welded, at a first end, to the metal object. The anchoring assembly further comprises a plurality of anchor fins connected to an anchoring nut. The anchoring nut is further screwed onto the mounting pin at a second end of the mounting pin.

The known anchoring assembly provides excellent results for anchoring a liner of a cured lining material to a metal object. The liner or lining material is a protective material which is often simply called “refractory” for protecting equipment against a high temperature and/or abrasive environment as a result of processes occurring inside vessels, conduits, cyclones and other installations. In specific areas of the equipment, the known anchoring assembly is less suitable for anchoring a liner. Hence, it is an object of the present invention to provide an improved refractory anchor configured for anchoring the liner in specific areas of the equipment.

### SUMMARY

This object is achieved with a refractory anchor disclosed herein.

The refractory anchor comprises an elongated mounting pin of which one end is weldable to an object, preferably by stud welding, and an anchor fin, preferably two anchor fins, connected to the elongated mounting pin. In the refractory anchor, the plate-like anchor fin extends outwardly seen from the elongated mounting pin in such a manner that seen from above the refractory anchor, the refractory anchor defines an outer side and an inner side, wherein the outer side and the inner side are divided by means of the plate-like anchor fin and the elongated mounting pin. In one aspect, two anchor fins are connected/fixed in a spaced manner on opposite sides on the circumference of the elongated mounting pin, i.e. the angle between each surface of two anchor fins facing towards the outer side is approximately 180 degrees or 180 degrees, such that the two anchor fins extend outwardly in two opposing directions seen from the elongated mounting pin.

As mentioned above, the known anchoring assembly is not suitable for specific areas in an equipment to be protected, for example in areas where the liner due to constructional reasons has to terminate. The borders of these areas are nowadays provided with hand weld custom plates acting as a kind of stop plate for the lining material, wherein the known plates have no or minimal contribution in anchoring the liner. In addition, hand welding these often custom made plates is a time-consuming process. The present inventors have realized that by providing a refractory anchor having an outer side free from any projections extending from the (two) plate-like anchor fin(s) and the elongated mounting pin into the outer side, it is possible to have a refractory anchor having a double function. The first function is the ability for anchoring a liner, in particular on the inner side of the refractory anchor, the second function is providing a support, or a stop/termination for forming a border where lining material should terminate.

The refractory anchor disclosed in this document provides advantages in these specific areas of the equipment with respect to installation time and anchoring quality of the liner after installation. The refractory anchor can be welded by stud welding to an object by means of the elongated mounting pin in a relatively fast manner. Further, the installation technique, in particular the welding technique used for welding the refractory anchor may be the same as welding the known anchoring assembly in other areas of the installation. Hence, the operator does not have to switch tools and requires no additional trainings for learning more than one welding technique. In addition, the refractory anchor can also be configured from a material perspective and/or a design perspective for anchoring the liner on the inner side. Although, the plate-like anchor fin(s) has no projections in at least the outer side such as for example further anchor fins connected to the elongated mounting pin in at least the outer side or between the two anchor fins in at least the outer side, it is possible to provide the anchor fin or at least one of the two anchor fins with tabs on the inner side facing the liner and/or to provide additional anchor fins connected to the elongated mounting pin on the inner side between the two main anchor fins defining the inner side and the outer side. In other words, it is possible to increase the anchoring results on the inner side by providing for example one or more additional anchor fins on the circumference portion of the elongated mounting pin projecting into the inner side or in the inner side between the two anchor fins defining the inner side and the outer side. However, in an advantageous aspect for manufacturing a termination plate-like assembly of refractory anchors, the refractory anchors to be used comprise no further anchor fins, i.e. each refractory anchor maximally comprises two anchor fins connected to the elongated mounting pin without additional anchor fins extending into the inner side.

The two anchor fins defining the inner side and the outer side may lie in one virtual plane. In this way it is possible to provide a termination plate section by the refractory anchor for lining material. The object, for example a wall or a metal plate, to which the refractory anchor may be welded does not have to be a flat surface, but as a result of the elongated mounting element the refractory anchor may advantageously be welded to an object having a curved gradient, such as for example an at least partially cylindrical object.

The anchor fin or the two anchor fins defining the inner side and the outer side is or are configured for providing a strip or a strip section around lining material positioned or to be positioned on at least the inner side of the refractory anchor.

In an aspect, the anchor fin has a connector or the two anchor fins are connected to each other by a connector, wherein the connector is connected to the elongated mounting pin, wherein the connector and the anchor fin(s) are made in one piece and/or from one and the same material. Such a connector can be used to connect the anchor fin(s) in a fast manner to the elongated mounting pin and provides a strong, reliable and long lasting connection between the anchor fin(s) and the elongated mounting pin.

In a further aspect, the connector provides a through hole for receiving the elongated mounting pin for providing a connection between the elongated mounting pin and the connector. A relatively fast, simple, safe and operator-friendly technique is by providing the connection between the elongated mounting pin and the connector by friction fit, i.e. after positioning the elongated mounting pin into the through hole, a second end of the elongated mounting pin opposite to the end to be welded to the object is subjected to pressure such that an end section directly located below the second end expands for fixing the end section inside the through-hole of the connector. Such a connection can be provided in a relatively fast manner and has provided excellent long lasting results, in particular inside high temperature processing vessels/cyclones.

Further, the elongated mounting pin may be advantageously made from a different material than the (two) anchor fin(s) and the connector if present. More specific, the elongated mounting pin is made from a first alloy and the (two) anchor fin(s) is (are) made of a second alloy different from the first alloy. The first alloy is for example configured for optimal welding results of the elongated mounting pin to an object such as for example a backing plate. The (two) anchor fin(s) is (are) made of a second alloy different from the first alloy, wherein the second alloy is configured for providing optimal anchoring results of the liner and/or for providing maximum protection against the high temperature and/or abrasive environment of processes occurring inside the vessel/cyclone. The elongated mounting pin is advantageously made of a material configured for stud welding the elongated mounting pin to an object, for example a metal plate. Hence, by using stud welding technique, the installation time of the refractory anchors is relatively fast, in particular compared to hand welding or spot welding.

Each of the two anchor fins defining the inner and the outer side of the refractory anchor is provided with a tab extending towards the inner side of the refractory anchor such that the refractory anchor provides excellent anchoring results on the inner of the refractory anchor. Each tab may further define an acute angle with the virtual plane, preferably the acute angle lies between 35-85 degrees, more preferably between 50-70 degrees.

In a further aspect, the elongated mounting pin comprises the end weldable to an object and a further (second) end opposite to the end weldable to an object seen in the longitudinal direction of the elongated mounting pin, wherein each anchor fin has an anchor fin portion extending above the further end of the elongated mounting pin seen in the longitudinal direction of the elongated mounting pin. The sides of the anchor fin portions facing each other define a space between these sides, wherein the space is directly located above the further end opposite to the end weldable to an object seen in the longitudinal direction of the elongated mounting pin. This space is also identified as a submerged section. This space provides stronger refractory anchors in vessels/cyclones in that the refractory anchors with these spaces are able to withstand higher temperatures. After installing the refractory anchor and after applying a lining material over the refractory anchor, the lining material fills the space and after curing the space is filled with liner. This liner in the space provides a temperature buffer, because the liner conducts heat less well than the refractory anchor, in particular the elongated mounting pin of the refractory anchor. After installation the hot side of the refractory anchor is the side which is furthest away from the object to which the refractory anchor has been welded. By providing the space between the sides of the anchor fin portions facing each other, which space is filled with heat-insulating liner, there is no direct heat path between the hot side located above upper sides of the anchor fin portions and the further (second) end of the elongated mounting pin. By burying the further (second) end of the elongated mounting pin with heat-insulating liner provided in the space of the submerged section, the temperatures in the elongated mounting pin, in particular towards the end of the elongated mounting pin welded or weldable to an object, can be reduced drastically. Under certain high temperature conditions in the vessel/cyclone, a direct heat path may damage the weld between the refractory anchor and the object. In these high-temperature situation the submerged section extends the life-time of the refractory anchor, without requiring undesired short maintenance or inspecting intervals. Hence, by providing the liner temperature buffer in the submerged section there is no direct heat path between the hottest side of the refractory anchor and the end welded to the object, which provides a longer lasting refractory anchor configured to be used in vessels/cyclones configured for relatively high-temperature processes.

In a different aspect, the sides of the anchor fin portions facing each other have a cut-out. These cut outs provide improved anchoring results of the liner in the space between these sides of the anchor fin portions facing each other and contribute in reducing a heat path from the hot side of the refractory anchor to the end of the elongated mounting pin welded or to be welded to the object.

The elongated mounting pin of the refractory may further comprise between a connection section of the elongated mounting pin with the (two) anchor fin(s) and the end weldable to an object, a section where there is a distance between the elongated mounting pin and a side of the anchor fin facing the elongated mounting pin or sides of the two anchor fins facing each other. This distance also reduces a direct or relatively short heat path between the anchor fin(s) and the end weldable to an object, such that a longer lasting refractory anchor can be provided. Further, it provides an improved flow path for the liquid lining material, which facilitates increasing the quality of the cured liner around the refractory anchor.

The or each plate-like anchor fin may have at least one rounded corner. In particular two corners of the plate-like anchor fin located after installation closer to an object than the other two corners of the plate-like anchor fin are rounded corners. The rounded corner reduces the risks of cracks in the liner compared to conventional straight corners drastically, because in use the refractory anchor may experience thermal expansion and/or vibrations as a result the sharp corners are able to cut into the cured lining material which may provide cracks/bursts in the liner. In particular, rounded corners of the anchor fin(s) being more submerged in the lining material than the corners located further away of the object provide excellent results against cracks/bursts in the liner.

The or each anchor fin side facing away from the elongated mounting pin comprises a cut-out between two corners of the plate-like anchor fin. These cut outs prevent or reduce heat transfer between two adjacent positioned refractory anchors. Further, the cut-out may facilitate providing improved anchoring results of the liner.

It is a further object to provide an assembly comprising an object and a number of the refractory anchors described above for providing a strip. This object is achieved with the claim directed to an assembly. In the assembly, an end of the anchor fin opposite to the elongated mounting pin of a first refractory anchor may be located against or adjacent an end of the anchor fin opposite to the elongated mounting pin of a second refractory anchor. The refractory anchors may be configured for providing a curved strip around the object by positioning the anchor fin(s) of the second refractory anchor under an angle smaller than 180 degrees with respect to the anchor fin(s) of the first refractory anchor, for example for following a curved object, such as a cylindrical wall.

It is also an object to provide a method for providing the above assembly. This object is achieved according to the claim directed to a method. The refractory anchors are joined to the object by stud welding, preferably drawn arc stud welding. Further, an end of the anchor fin opposite to the elongated mounting pin of a first refractory anchor may be positioned against or adjacent an end of the anchor fin opposite to the elongated mounting pin of a second refractory anchor. In addition, the anchor fin(s) of the second refractory anchor may be positioned under an angle smaller than 180 degrees with respect to the anchor fin(s) of the first refractory anchor, for example for following a curved object, such as a cylindrical wall.

### BRIEF DESCRIPTION OF THE DRAWINGS

The present invention will be explained in more detail below with reference to the appended figures showing exemplary embodiments of a refractory anchor.

FIGS. 1a, 1 b, 1c, 1d, 1e, and 1f show various respective views of a first embodiment of a refractory anchor;

FIGS. 2a, 2b, 2c, 2d, 2e, and 2f show various respective views of a second embodiment of a refractory anchor.

### DETAILED DESCRIPTION

Like parts are indicated by the same reference signs in the various figures.

Each feature disclosed with reference to the figure can also be combined with another feature disclosed in this disclosure including the claims, unless it is evident for a person skilled in the art that these features are incompatible.

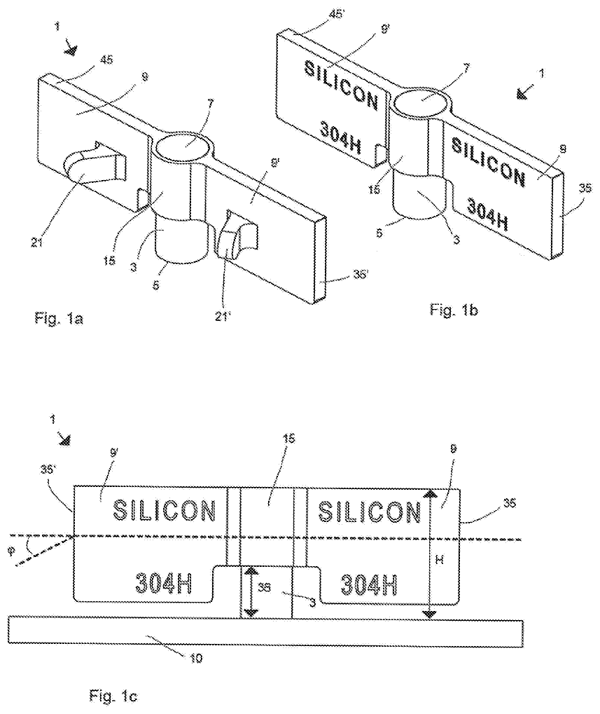

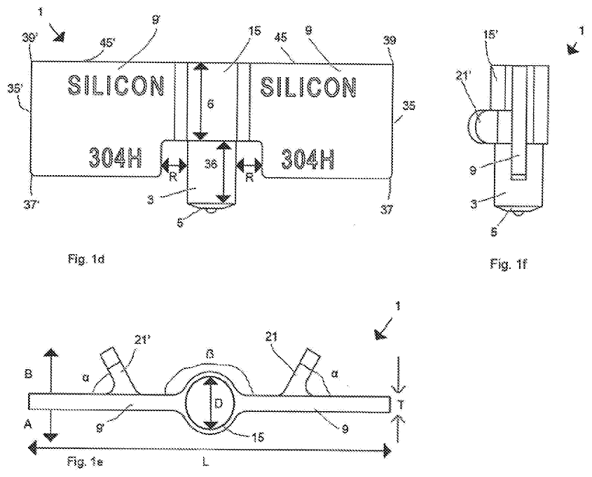

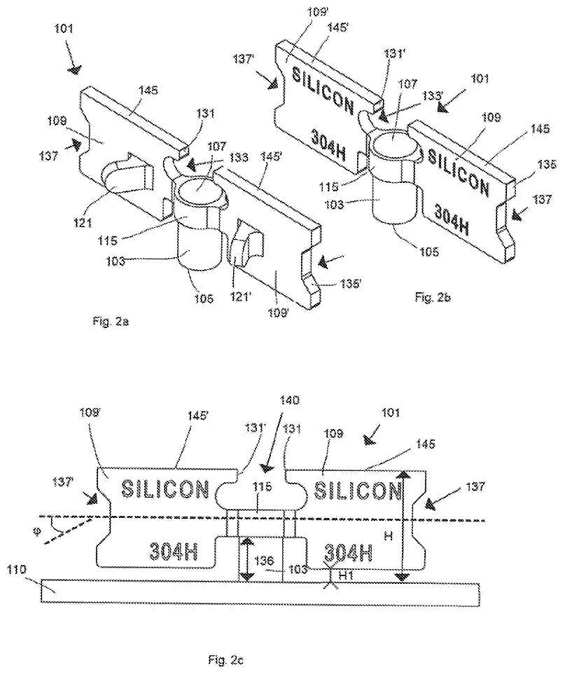

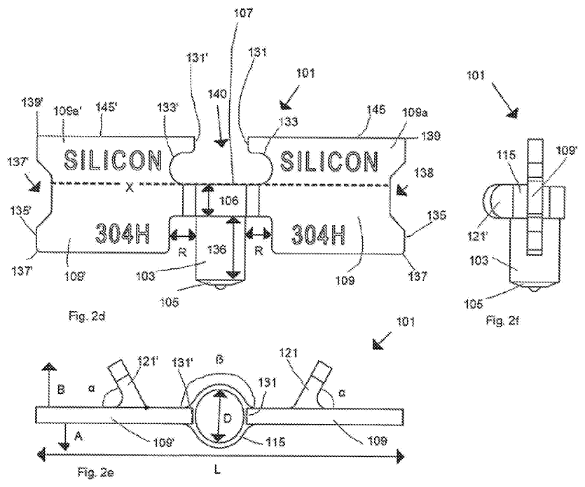

FIGS. 1a-1f and 2a-2f show perspective, front, top and side views from two different embodiments of a refractory anchor 1; 101 disclosed in this document.

The differences between these refractory anchors 1; 101 will be discussed in detail further below. The two refractory anchors 1; 101 both comprise an elongated mounting pin 3; 103 of which a first end 5; 105 is weldable to an object 10; 110 and two plate-like anchor fins 9, 9′; 109, 109′ connected to an end section or connection section indicated by arrow 6; 106 adjacent a second end 7; 107 of the elongated mounting pin 3; 103. The two plate-like anchor fins 9, 9′; 109, 109′ extend outwardly in two opposing directions seen from the elongated mounting pin 3; 103 in such a manner that seen from above the refractory anchor 1; 101, see for example FIGS. 1e and 2e showing a top view of the refractory anchor 1; 101, the refractory anchor 1; 101 defines an outer side indicated by arrow A and an inner side indicated by arrow B. The outer side A and the inner side B are divided by means of the two plate-like anchor fins 9, 9′; 109, 109′ and the elongated mounting pin 3; 103, in particular in the embodiments shows a connector 15; 115 around the elongated mounting pin 3; 103 for connecting the two plate-like anchor fins 9, 9′; 109, 109 to the elongated mounting pin 3; 103. As can be seen in FIGS. 1a, 2a, 1e, 2e the outer side A is free from any projections extending from the two plate-like anchor fins 9, 9′; 109, 109′ and the elongated mounting pin 3; 103 into the outer side A. The angle ß (FIGS. 1e, 2e) between each surface of two anchor fins facing towards the outer side is 180 degrees. The angle ß may be approximately 180 degrees, wherein approximately means plus minus 10 degrees. As described above, the refractory anchor 1; 101 has two functions, i.e. the first function is anchoring a liner, in particular on the inner side of the refractory anchor 1; 101, the second function is providing a support, or a stop/termination for forming a border where lining material should terminate. Further, a relatively fast installation time is provided by means of the elongated mounting pin 3, 103 of the refractory anchor 1; 101, which may be welded by stud welding to an object.

The two plate-like anchor fins 9, 9′; 109, 109′ of each refractory anchor 1, 101 are identical. Further, as can be seen best in FIGS. 1e and 2e the two anchor fins 9, 9′; 109, 109′ of each refractory anchor 1, 101 defining the inner side B and the outer side A lie in one virtual plane. This virtual plane also extends through the center line (not shown) of the elongated mounting pin 3; 103. The two plate-like anchor fins 9, 9′; 109, 109′ are mirror symmetrical with respect to a plane through the center line of the elongated mounting pin 3; 103 and perpendicular to the virtual plane in which the two anchor fins 9, 9′; 109, 109′ of the refractory anchor 1, 101 extend. The two plate-like anchor fins 9, 9′; 109, 109′ of each refractory anchor 1, 101 are configured for forming a strip or a strip section around lining material positioned or to be positioned on at least the inner side B of the refractory anchor 1, 101.

In addition, the refractory anchor 1, 101 is configured from a material perspective and/or a design perspective to contribute in anchoring the liner on the inner side. It is possible to provide at least one of the two anchor fins with tabs on the inner side facing the liner. As shown in the figures each of the two anchor fins 9, 9′; 109, 109′ defining the inner and the outer side of the refractory anchor is provided with a tab 21, 21′; 12, 121′ extending towards the inner side B of the refractory anchor 1, 101. Each tab 21, 21′; 12, 121′ defines an acute angle α with the anchor fin 9, 9′; 109, 109′. The acute angle lies between 35-85 degrees, more preferably between 50-70 degrees. To further improve the liner anchoring results it is further optionally possible to provide additional anchor fins (not shown) connected to the elongated mounting pin 3; 103 on the inner side A between the two main anchor fins 9, 9′; 109, 109′ defining the inner side A and the outer side B.

The two plate-like anchor fins 9, 9′; 109, 109′ of each refractory anchor 1, 101 are connected to each other by the connector 15; 115 as mentioned above, wherein the connector is connected to the elongated mounting pin 3; 103. The connector 15; 115 and the two anchor fins 9, 9′; 109, 109′ are made in one piece, and the connector and the two anchor fins 9, 9′; 109, 109′ are made from the same material, wherein the composition of this material is configured for providing long lasting results for anchoring a liner. The connector 15; 15′ comprises a through hole 19; 119 for receiving the connection section 6; 106 of the elongated mounting pin 3; 103 for providing a connection between the elongated mounting pin 3; 103 and the connector 15; 115, wherein the connection between the elongated mounting pin 3; 103 and the connector 15; 115 is provided by friction fit which has various advantages in that the friction fit is faster, simpler, safer and more operator-friendly over other known connecting techniques such as an inner thread (not shown) of the through hole cooperating with an outer thread (not shown) on the elongated mounting pin or by welding the connector to the elongated mounting pin.

The elongated mounting pin 3, 103 further comprises a section indicated by arrow 36, 136 below the second section 6, 106 where there is a distance indicated by arrow R (FIGS. 1d, 2d) between sides of the anchor fins 9, 9′; 109, 109′ facing each other and the elongated mounting pin 3, 103. This distance R reduces a direct or relatively short heat path between the upper sides 45, 45′; 145, 145′ (FIGS. 1a,b and 2a,b) of the anchor fins 9, 9′; 109, 109′ and the end 5, 105 of the elongated mounting pin 3, 103 weldable or welded to object 10; 110, such that a refractory anchor can be provided with an improved configuration to withstand high temperatures on the “hot side” of the refractory anchor 1; 101. After installation, the upper sides 45, 45′; 145, 145′ of the refractory anchor 1, 101 are facing the “hot side”.

Further, each plate-like anchor fin 9, 9′; 109, 109′ of the refractory anchor 1; 101 has at least one rounded corner 37, 37′; 137, 137′, i.e. the two corners 37, 37′; 137, 137′ of each plate-like anchor fin 9, 9′; 109, 109′ located after installation closer to the object 10; 110 than the other two corners 39, 39′; 139, 139′ of each plate-like anchor fin 9, 9′; 109, 109′ are rounded corners. Without being bound by theory, the modification of the corners 37, 37′; 137, 137′ close to the object into round corners instead of sharp corners has reduced the number of cracks after a predetermined time period of use in the liner drastically. Of course, it is also possible to make all corners of the anchor fin 9, 9′; 109, 109′ round.

The refractory anchor 1, 101 only comprises two anchor fins 9, 9′; 109, 109′. Such a refractory anchor 1, 101 provides excellent liner anchor results on the inner side B and is able to provide a plate-like border function on the outer side A.

The main difference between the refractory anchor 1 shown in FIGS. 1a-f and the refractory anchor 101 shown in FIGS. 2a-f is that the refractory anchor 1 is normally used as a termination plate, such that after installation of the refractory anchor 1 and applying lining material, there is only lining material on the inner side B of the refractory anchor 1 shown in FIGS. 1a-f, whereas the refractory anchor 101 shown in FIGS. 2a-f is used as a supporting element to be used in a termination zone in which lining material is located on both the inner side B and the outer side A, wherein on the outer side A the lining material ends within a predetermined distance for forming a border together. The predetermined distance is relatively short, for example smaller than the longest dimension of the refractory anchor 1, i.e. defined by the outer ends of the two anchor fins 109, 109′ and identified by arrow L in FIG. 2e.

In the refractory anchor 101, each anchor fin has an anchor fin portion 109a, 109a′ (indicated by a dotted line X in the anchor fins in FIG. 2d) extending above the second end 107 of the elongated mounting pin 103 seen in the longitudinal direction of the elongated mounting pin 103. The sides 131, 131′ of the anchor fin portions 109a, 109a′ facing each other define a space 140 between these sides 131, 131′. This space 140 provides a submerged section and this submerged section can be filled with lining material providing a liner temperature buffer in the submerged section such that there is no direct heat path between the hottest side of the refractory anchor and the end 105 welded to the object 110. For the sake of brevity reference is made to the above description for the advantages of the submerged section. As can be seen in the front view of FIG. 2d both sides 131, 131′ of the anchor fin portions 109a, 109a′ facing each other have a cut-out 133, 133′. Further, each anchor fin side 135, 135′ facing away from the elongated mounting pin 103 comprises a cut-out 138, 138′ between two corners 137, 139; 137′, 139′ of the plate-like anchor fins 109, 109′.

In FIGS. 1c and 2c a portion of an assembly as claimed is shown, i.e. the assembly comprises an object 10; 110 and a number of refractory anchors 1, 101 for forming a strip, wherein in FIGS. 1c and 2c only one refractory anchor 1, 101 is shown.

Further, it is noted that the anchor fins 9, 9′; 109, 109′ also have a minimal horizontal spacing/height H2 as shown in FIG. 2c between the a virtual horizontal plane (for example the object 10; 110 in FIGS. 1c and 2c) around the first end 5; 105 of the elongated mounting pin 3; 103 and the underside of the anchor fins 9, 9′; 109, 109′. In the refractory anchor 1, 101 the mounting pin 3; 103 is arranged with respect to the anchor fins 9, 9′; 109, 109′ to provide this minimal vertical height H2. This minimal vertical height H2 of the refractory anchor 1, 101 is important during installation to guarantee that lining material in liquid form is free to flow under the anchor fins 9, 9′; 109, 109′ to obtain excellent lining results.

For providing an assembly an end/side 35, 35′; 135, 135′ of the anchor fin 9, 9′; 109, 109′ opposite to the elongated mounting pin 3; 103 of a first refractory anchor 3; 103 is located adjacent or against, an end/side 35, 35′; 135, 135′ of the anchor fin 9, 9′; 109, 109′ opposite to the elongated mounting pin 3; 103 of a second refractory anchor (not shown in FIGS. 1c and 2c). In the method for manufacturing the assembly, the refractory anchors are joined to the object by stud welding, preferably drawn arc stud welding. The object 10, 110 shown in FIGS. 1c and 2 is flat, but the refractory anchors are configured for providing a curved strip around an object having a radius of curvature such as for example a cylindrical wall. The curved strip can be easily obtained by positioning the anchor fins of the second refractory anchor (not shown) under an angle φ (FIGS. 1c, 2c) smaller than 180 degrees with respect to the anchor fins of the first refractory anchor 1, 101. Such a strip can be obtained if the longest dimension L of the refractory anchors 1, 101 is relatively small, i.e. smaller than 20 cm for example approximately 8 cm. Each anchor fin 9, 9′; 109, 109′ may have a thickness indicated by arrows T smaller than 1 cm for example approximately 3 mm. The height indicated by arrow H of the refractory anchor 1, 101 measured from the object 10, 110 is smaller than 7.5 cm, for example 2.5 cm. As shown in the drawings the elongated mounting pin 3; 103 has a cylindrical shape. However, different shaped pins having corners for forming a pin having a polygonal cross-section can also be used, for example a plate shaped pin. The diameter indicated by arrow D of the elongated mounting 3; 103 is smaller than 2.5 cm, for example 1 cm.

It is further possible to provide a refractory anchor having a plate-like anchor fin (not shown in the figures), wherein the refractory anchor defines an outer side and an inner side, wherein the outer side and the inner side are divided by means of the plate-like anchor fin and the elongated mounting pin, wherein the outer side is free from any projections extending from the plate-like anchor fin and the elongated mounting pin into the outer side.

1. A refractory anchor comprising:
an elongated mounting pin of which one end is weldable to an object and a plate-like anchor fin connected to the elongated mounting pin, wherein in that the plate-like anchor fin extends outwardly seen from the elongated mounting pin in such a manner that seen from above the refractory anchor, the refractory anchor defines an outer side and an inner side, wherein the outer side and the inner side are divided by means of the plate-like anchor fin and the elongated mounting pin, wherein the outer side is free from any projections extending from the plate-like anchor fin and the elongated mounting pin into the outer side.

2. The refractory anchor according to claim 1, wherein two plate-like anchor fins are connected to the elongated mounting pin, wherein the two plate-like anchor fins extend outwardly in two opposing directions seen from the elongated mounting pin in such a manner that seen from above the refractory anchor, the outer side and the inner side are divided by means of the two plate-like anchor fins and the elongated mounting pin, wherein the outer side is free from any projections extending from the two plate-like anchor fins and the elongated mounting pin into the outer side.

3. The refractory anchor according to claim 2, wherein the two anchor fins defining the inner side and the outer side lie in one virtual plane.

4. The refractory anchor according to claim 1, wherein the refractory anchor is configured as a strip or as a strip section around lining material positioned or to be positioned on at least the inner side of the refractory anchor.

5. The refractory anchor according claim 1, wherein the anchor fin(s) is connected to a connector, wherein the connector is connected to the elongated mounting pin, wherein the connector and the anchor fin(s) are made in one piece, and/or the connector and the anchor fin(s) are made from the same material.

6. The refractory anchor according to claim 5, wherein the connector provides a through hole for receiving the elongated mounting pin for providing a connection between the elongated mounting pin and the connector, wherein the connection between the elongated mounting pin and the connector is provided by friction fit.

7. The refractory anchor according to claim 1, wherein the elongated mounting pin is made from a different material than the at least one anchor fin.

8. The refractory anchor according to claim 7, wherein the elongated mounting pin is made from a first alloy and the anchor fin(s) is made of a second alloy different from the first alloy.

9. The refractory anchor according to claim 1, wherein the elongated mounting pin is made of a material configured for stud welding the elongated mounting pin to an object.

10. The refractory anchor according to claim 2, wherein each of the two anchor fins defining the inner and the outer side of the refractory anchor is provided with a tab extending towards the inner side of the refractory anchor.

11. The refractory anchor according to claim 10, wherein each tab defines an acute angle with the anchor fin, wherein the acute angle lies between 35-85 degrees.

12. The refractory anchor according claim 2, wherein the elongated mounting pin comprises the end weldable to an object and a further end opposite to the end weldable to an object seen in the longitudinal direction of the elongated mounting pin, wherein each anchor fin has an anchor fin portion extending above the further end of the elongated mounting pin seen in the longitudinal direction of the elongated mounting pin.

13. The refractory anchor according to claim 12, wherein the sides of the anchor fin portions facing each other have a cut-out.

14. The refractory anchor according to claim 1, wherein between a connection section of the elongated mounting pin with the anchor fin(s) and the end weldable to an object, the elongated mounting pin comprises a section where there is a distance between a side of the anchor fin facing the elongated mounting pin and the elongated mounting pin.

15. The refractory anchor according to claim 1, wherein the plate-like anchor fin has at least one rounded corner, in particular two corners of the plate-like anchor fin located after installation closer to an object than the other two corners of the plate-like anchor fin are rounded corners.

16. The refractory anchor according claim 1, wherein an anchor fin side facing away from the elongated mounting pin comprises a cut-out between two corners of the plate-like anchor fin.

17. The refractory anchor according claim 1, wherein the refractory anchor comprises only two anchor fins.

18. An assembly comprising an object and a number of refractory anchors welded on the object for providing a strip, wherein each refractory anchor comprising an elongated mounting pin of which one end is weldable to an object and a plate-like anchor fin connected to the elongated mounting pin, wherein in that the plate-like anchor fin extends outwardly seen from the elongated mounting pin in such a manner that seen from above the refractory anchor, the refractory anchor defines an outer side and an inner side, wherein the outer side and the inner side are divided by means of the plate-like anchor fin and the elongated mounting pin, wherein the outer side is free from any projections extending from the plate-like anchor fin and the elongated mounting pin into the outer side.

19. The assembly according to claim 18, wherein an end of the anchor fin opposite to the elongated mounting pin of a first refractory anchor is located adjacentor against, an end of the anchor fin opposite to the elongated mounting pin of a second refractory anchor.

20. The assembly according to claim 19, wherein the refractory anchors are configured for providing a curved strip around the object by positioning the anchor fin(s) of the second refractory anchor under an angle smaller than 180 degrees with respect to the anchor fin(s) of the first refractory anchor.

21. A method for providing an assembly according to claim 18, wherein the elongated mounting pin of the refractory anchors are joined to the object by stud welding.

22. The method according to claim 21, wherein an end of the anchor fin opposite to the elongated mounting pin of a first refractory anchor is positioned adjacent, or against, an end of the anchor fin opposite to the elongated mounting pin of a second refractory anchor.

23. The method according to claim 22, wherein the anchor fin(s) of the second refractory anchor is positioned under an angle smaller than 180 degrees with respect to the anchor fin(s) of the first refractory anchor.
